(19) United States
(12) Patent Application Publication
(10) Pub. No.: US 2023/0089028 A1
(43) Pub. Date: Mar. 23, 2023

(54) APPARATUS AND METHOD FOR MIXING ELASTOMERIC MATERIALS

(71) Applicant: POMINI RUBBER & PLASTICS S.R.L., RESCALDINA (IT)

(72) Inventors: ROBERTO REGALIA, RESCALDINA (IT); ANDREAS ALBERT LIMPER, RESCALDINA (IT)

(21) Appl. No.: 17/795,691

(22) PCT Filed: Feb. 18, 2021
(86) PCT No.: PCT/IB2021/051374

§ 371 Date: Jul. 27, 2022

(30) Foreign Application Priority Data
Feb. 20, 2020 (IT) 102020000003515

(51) Int. Cl. B29B 7/74; B29B 7/48; B29B 7/72; B29B 7/90; B29C 48/40; B29C 48/41; B29C 48/525; B29B 7/82

(52) U.S. Cl. CPC B29B 7/7495; B29B 7/90; B29B 7/484; B29B 7/488; B29B 7/726; B29B 7/728; B29B 7/823; B29C 48/41; B29C 48/402; B29C 48/525

(57) ABSTRACT

A Machine for mixing elastomeric materials with a mixing unit, and a drive unit; the mixing unit has a mixing chamber arranged downstream of the drive unit and closed by a rear wall, a discharge chamber arranged downstream of the mixing chamber, with which it communicates and provided with an opening for discharging the mixture; a pair of inter-penetrating and counter-rotating conical rotors connected with the drive unit and having their vertices situated at the mouth of the discharge chamber. The rotors are rotated by the drive unit in a first sense (RPM+) to cause the mixture to be pushed towards the rear wall of the mixing chamber so as to keep mixing active only inside the mixing chamber, and in second sense of rotation, opposite to the first sense, to cause the mixture to be pushed towards the chamber and the discharge opening for discharging thereof.

### DESCRIPTION

The present invention relates to a machine for mixing elastomeric materials with a mixing chamber operating at ambient pressure.

It is known in the technical sector relating to the production of rubber and/or plastic-based compounds that there exists the need to perform the mixing of elastomeric materials by means of which, using a suitable process, several raw materials (ingredients) which are heterogeneous (for example, rubbers, mineral fillers, resins, various additives) and different and separate from each other are converted into a homogeneous product - the so-called “compound” - which incorporates all the base components introduced at the start of the process, being homogeneous once mixing is completed.

It is also known that the actions which generally occur during the mixing process may be summarized as follows:

### Incorporation of the Ingredients in the Polymer Matrix

Dispersion, i.e. the transformation from agglomerates of particles into aggregates; this basically consists in the reduction of the size of the fillers (for example carbon black) introduced into the polymer matrix;

Distribution/homogenization of all the primary materials.

It is also known that all these actions depend on the movement range (speed and pressure) imparted to the materials being processed by the movement of the moving surfaces (cylinders, screws, rotors) of the mixing machines. In particular, it is known that, while the dispersion depends on the characteristics of the movement range, such as the cutting force and deformation gradient, the distribution of the various ingredients in the polymer matrix depends on the efficiency of the speed range, i.e. the possibility of moving the mixture without creating stagnation points or zones of the mixture where there are pressure peaks.

One of the main problems to be dealt with during the process of mixing highly viscous materials, however, consists in the need to control the temperature of the mixture, which must be kept within certain limits to prevent the triggering of undesirable degradation or pre-crosslinking reactions.

Higher temperatures arise more significantly in those technologies which involve mixing in so-called closed chambers, since processing takes place at pressures which in turn are relatively high.

The undesirable increase in temperature during mixing also occurs during the mixing performed by means of machines of the type which are generally known as “dump extruders”, namely so-called conical, inter-penetrating, counter-rotating twin-screw extruders, in which the discharge/outlet zone of the machine for discharge/outlet of the mixture must be:
closed during a first mixing step in order to allow recirculation of the ingredients and the mixture being formed, which is made to advance against a closing door for closing a discharge opening; and
then opened in the axial direction by means of said door, in order to allow discharging of the mixture.

Examples of such machines are for example known from US 2007/0159916. Mixing inside closed chambers, however, results in the uncontrolled and undesirable increase in the temperature of the mixture with the consequent drawbacks mentioned above.

A further example of closed-chamber mixing is known from WO2017-093849, which describes a process for the production of an elastomeric compound comprising:
feeding into a batch mixer, comprising a pair of rotors housed inside a mixing chamber and a piston arranged above the rotors, together with an elastomeric polymer, at least 10 phr of silica reinforcing filler and at least one silane coupling agent;
mixing inside the batch mixer the elastomeric polymer, the silica reinforcing filler and the silane coupling agent so as to obtain a batch of an intermediate mixture;
feeding the batch of intermediate mixture from the batch mixer to a twin-screw conical mixer having a mixing chamber provided with an inlet mouth and an outlet mouth, with a first chamber part close to the outlet mouth (discharge chamber) and arranged downstream of a second chamber part, provided with said inlet mouth, two counter-rotating conical screws converging towards the outlet mouth, and a door designed to assume a configuration for closing and opening the outlet mouth;
mixing the intermediate mixture inside the twin-screw conical mixer with the door closed while controlling the temperature which is kept between 135 and 145° C. in order to obtain the elastomeric compound (108);
discharging the elastomeric compound from the open outlet mouth.

In the process according to WO2017-093849, mixing is performed almost entirely inside the part of the twin-screw mixer chamber close to the closed outlet mouth, with the conical screws which rotate in a first sense of rotation so as to push the mixture against the door which closes the outlet mouth.

The pressure inside the twin-screw conical mixer is greater than the ambient pressure since the mixer is connected sealingly with the outlet of the batch mixer inside which the pressure is high owing to the action of the piston, the outlet mouth is closed and the temperature must be kept high (135-145° C.) so that at least 50% of the quantity of silane coupling agent reacts with the reinforcing filler inside the twin-screw conical mixer.

In order to improve mixing, the document propose inverting for brief periods the direction of rotation of the conical screws, without however the mixture leaving the mixing chamber part proximal to the closed outlet mouth.

In W02017-093849, in order to keep the temperature within the desired range, the temperature is measured inside the chamber and, based on the measurement, a speed of rotation of the conical screws is adjusted in the direction of advancing movement of the mixture towards the outlet mouth and against the closing door thereof.

The technical problem which is posed, therefore, is that of providing mixing machines of the type known generally as “dump extruders” which are able to solve or at least partially overcome the said problems of the prior art, allowing the mixing of elastomeric materials without alteration of their properties or only limited alteration thereof and allowing in particular the temperature of the mixture to be kept under control, preventing an undesirable increase thereof during mixing.

In connection with this problem, it is also required that this machine should have small dimensions, be easy and inexpensive to produce and assemble and be able to be easily installed also in any user location.

These results are obtained according to the present invention by a machine for the mixing of elastomer-based materials according to the present disclosure.

The machine comprises a mixing unit and a drive unit, the mixing unit comprising:
a mixing chamber arranged downstream of the drive unit and closed towards upstream by a rear wall;
a discharge chamber arranged downstream of the mixing chamber, with which it communicates towards upstream, and provided with a discharge opening for discharging the mixture;
a pair of inter-penetrating and counter-rotating conical rotors which are respectively connected upstream with the drive unit and have their vertices situated at the discharge opening of the discharge chamber; each rotor comprising a respective feeder screw mirror-inverted with respect to the other one.

The machine according to the present invention is characterized in that the mixing chamber has at least one opening towards the external environment adapted to keep it connected with the outside so as to ensure that its internal pressure remains at substantially atmospheric values and in that, for mixing, the rotors are made to rotate by means of the drive unit only in a first sense of rotation able to cause the mixture to be pushed towards the rear wall of the mixing chamber, so as to keep mixing active only inside the mixing chamber during the mixing step. In order to discharge the mixture during the following discharge step, the rotors may be made to rotate with a second sense of rotation, opposite to the first sense, able to cause the mixture to be pushed towards the chamber and the discharge opening.

With this configuration, the ingredients being mixed are kept substantially always inside the mixing chamber which, being open towards the surrounding environment and therefore at a substantially atmospheric pressure, does not cause undesirable increases in the pressure and/or the temperature of the mixture, avoiding damaging effects on the mixture such as alteration of the chemico-physical characteristics of the fillers and/or pre-crosslinking of the mixture itself; an optimum degree of mixing is furthermore obtained. With the machine according to the present invention it is therefore possible to obtain in a simple manner a high quality of the mixture.

Advantageously, the machine does not require doors for closing the discharge mouth, which may be kept open during mixing, making it easier to maintain the ambient pressure inside the mixing chamber and resulting in a simplification of the structure and configuration of the machine.

Preferably, the mixing chamber and the discharge chamber are frustoconical and axially connected together.

The machine preferably comprises a loading opening for loading the ingredients to be mixed, which in particular may be one of said at least one opening for connecting to the outside environment the mixing chamber.

According to a preferred embodiment, the drive unit comprises at least one motor with a shaft for moving one of the two rotors and a transmission designed to cause reversal of the sense of rotation of the drive shaft and connected to the other one of the two rotors.

The machine may advantageously comprise control means for controlling and actuating the moving parts of the machine, designed to perform automatic operation thereof. Preferably said control means are configured to send automatically to the drive unit a command for reversing the sense of rotation of the rotors when mixing has been completed, in particular after a predefined mixing time.

According to a preferred aspect, a cover is movable into a closed or open position so as to close the mixing chamber during the axial discharging of the mixture.

The present invention relates furthermore to a mixing process for mixing elastomeric materials, which comprises the steps of:
loading the ingredients to be mixed inside the mixing chamber;
mixing the ingredients by the feeder screws, with rotation of the rotors only in a first positive sense and pushing of the mixture towards the rear wall;
discharging the mixture, comprising reversal of the sense of rotation of the rotors which rotate in a second negative sense of rotation for a time period such as to cause the mixture to be pushed towards the discharge chamber and discharged through the discharge opening.

Preferably, during the mixing step, the rotation of the rotors in the first sense of rotation produces:
a reaction by the rear wall able to impart a movement component in the axial direction from upstream to downstream;
the formation of a movement range designed to produce three different movements of the mixture, i.e. a circumferential movement, a main axial flow movement and a secondary axial flow movement.

Loading of the ingredients preferably occurs from a loading opening, which is preferably one of said at least one opening towards the outside of the mixing chamber. The loading opening may advantageously be closed during the discharge step.

According to a preferred embodiment, the mixing step comprises the following steps:
starting rotation of the rotors in a first positive sense;
take-up of the ingredients by the feeder screws and starting mixing with pushing of the mixture towards the rear upstream wall;
maintaining the first positive sense of rotation for a mixing time until mixing has been completed.

According to a preferred embodiment, the discharge step comprises the following steps:
imparting - manually or via control means - a command for reversal of the sense of rotation of the two rotors;
reversal of the sense of rotation of the rotors which are made to rotate in a second, negative, sense of rotation for a time period such as to cause the mixture to be pushed towards the discharge chamber and discharged through the discharge opening.

Further details may be obtained from the following description of a nonlimiting example of embodiment of the subject of the present invention provided with reference to the attached drawings in which:

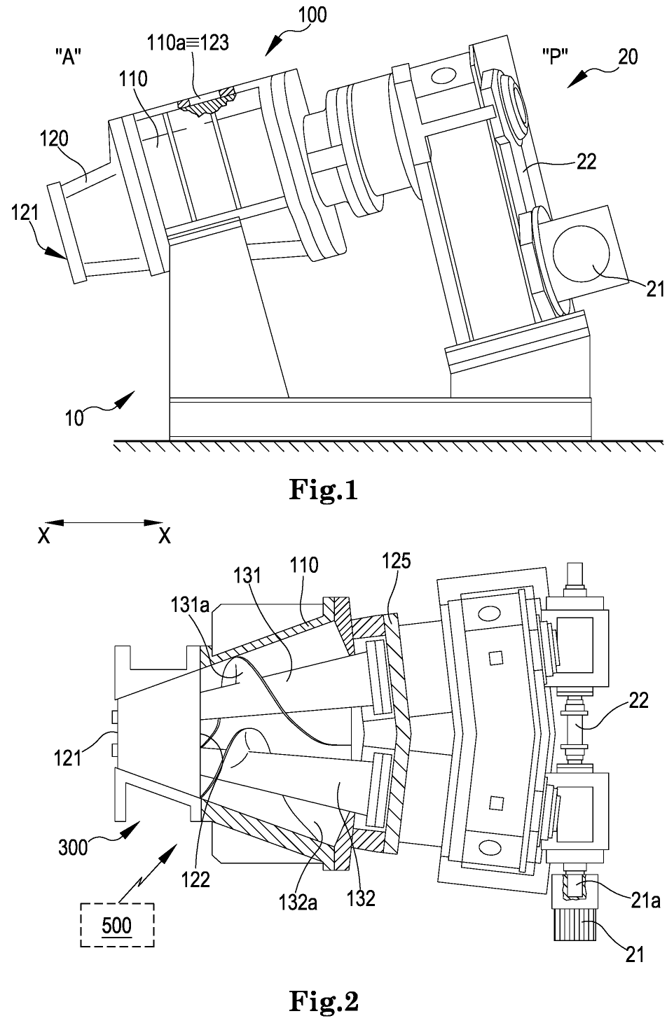

FIG. 1: shows a side view of the machine according to the present invention;

FIG. 2: shows a view from above of the machine according to FIG. 1;

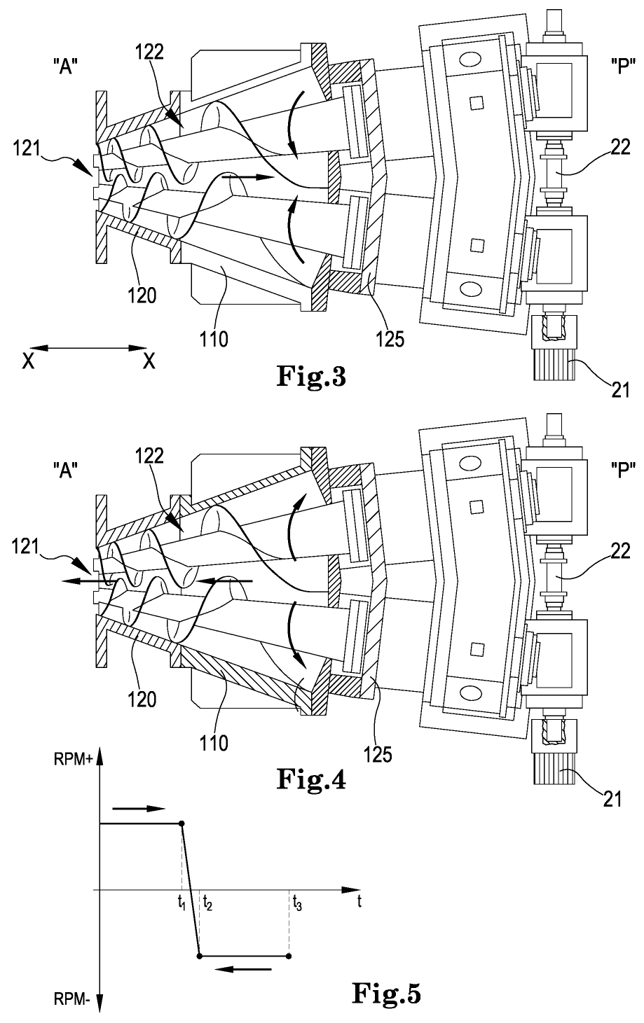

FIG. 3: shows a partially sectioned view from above of a machine according to FIG. 1 during mixing with an axial movement of the material towards the rear part;

FIG. 4: shows a partially sectioned view from above of the machine according to FIG. 3 during discharging with pushing and axial movement of the material towards the front part; and

FIG. 5: is a diagram illustrating the various operating steps of the machine according to the invention.

As shown in FIG. 1 and assuming solely for easier description and without a limiting meaning a reference axis with a longitudinal direction X-X corresponding to the lengthwise extension of the machine; as well as a front part A or downstream part, corresponding to the part where the mixture exits and a rear part P, or upstream part, opposite to the front part, an example of the machine according to the invention which, in its general configuration, falls within the general category of “dump extruders” comprises essentially:
a support base 10 for the functional units;
a mixing unit 100;
a drive unit 20, comprising at least one motor 21, with its shaft 21a connected to a transmission 22 designed to reverse the sense of rotation of the drive shaft 21a as will emerge more clearly below.

The mixing unit 100 comprises:
a mixing chamber 110, preferably frustoconical, arranged downstream of the drive unit 20; the mixing chamber comprises an upstream wall 125 which axially closes the chamber towards the rear part P;
a discharge chamber 120 for discharging the mixture, which is in turn preferably frustoconical, arranged downstream of the mixing chamber 110 and provided with an opening 121 for discharging the mixture in the axial direction, arranged in the front part “A” of the machine and with the upstream part mechanically connected to the mixing chamber with which it communicates in the axial direction by means of a corresponding opening 122.

Preferably, the mixing chamber 110 has an opening 123 for loading the raw materials (ingredients) to be mixed;
a pair of inter-penetrating conical rotors 131, 132, which are respectively connected upstream to the drive unit 20 and have their vertices at the mouth 121 of the discharge chamber 120; each rotor comprises a respective feeder screw 131a,132a mirror-inverted (with an opposite winding sense) with respect to the other one.

The two rotors 131, 132 are counter-rotating; in the example described, one 132 of the two rotors 131,132 maintains the direction of rotation of the motor 20, while the other rotor 131 receives the movement from the transmission 22, therefore always rotating in the opposite direction to the first rotor.

It is envisaged also that the two rotors may be each operated by an associated motor, independent of the other motor, but connected by synchronization means designed to ensure the correct rotation and prevent the feeder screws from colliding.

Advantageously, the mixing chamber 110 has at least one opening 110a in the radial direction, formed in the upwards directed part of its side surface and designed to keep the mixing chamber connected to the outside and therefore the pressure inside it at substantially atmospheric values.

It is feasible that the opening 110a and the opening 123 for loading the raw materials may coincide.

The discharge chamber has, instead, a radially closed surface and only a front opening 121 for discharging in the axial direction the mixture obtained. Advantageously, the front discharge opening 121 may be always open towards the outside or downstream devices, a door for closing the discharge chamber 120 not being necessary nor useful since the mixing always and only takes place inside the upstream mixing chamber 110 under atmospheric pressure.

A further simplification and improvement compared to the known machines is therefore obtained since the absence of means for closing the discharge opening helps keeping the mixing at atmospheric pressure inside the mixing chamber, improving the quality of the mixture obtained, and eliminates the need for complicated automatic systems for opening and closing the discharge chamber.

As shown (FIGS. 3,4) the rotors 131,132 have a feeder screw 131a,132a which respectively extend so as to cause, with a respective first sense of rotation (FIG. 3), a movement of the mixture from downstream to upstream and, with a respective reversed sense of rotation (FIG. 4), a movement of the mixture in the downstream direction towards the discharge opening 121. Control means 500 for controlling and actuating the moving parts of the machine may also be provided, said means being designed to ensure automatic operation of the machine.

With reference to the embodiment of the machine shown, it is possible to control operation thereof as follows:
rotors 131,132 configured with feeder screws 131a,132a such that, when they are rotated in the senses as shown in FIG. 3 - conventionally in a positive sense RPM+ - they are able to cause a movement of the mixture in the axial direction from downstream “A” to upstream “P”;
loading of the ingredients through the feeder mouth 123;
starting rotation of the rotors in a first positive sense RPM+, maintained for a time period t1 (FIG. 5);
the ingredients fed are taken up by the feeder screws 131a,132a of the rotors and, as a result of rotation thereof, start mixing, pushing the mixture towards the upstream wall 125;
pushing against the wall 125 causes a reaction, a so-called backflow, which tends to impart a movement component in the axial direction from upstream to downstream namely in the opposite direction to the preferred direction from downstream to upstream.

The movement range obtained is preferably composed of three movements, i.e.:
1st movement: circumferential, generated by the rotation of the rotors;
2nd movement: main axial flow generated by the form of the feeder screws;
3rd movement: secondary axial flow or backflow, generated by the resistance of the wall 125 which, opposing the main axial flow, tends to cause the mixture being formed to flow back in the downstream direction.

This movement range is that which is preferred in order to obtain mixing;
once a satisfactory degree of mixing has been obtained:
manual or automatic reversal by the control unit 500 of the sense of rotation of the two rotors 131,132;
reversal of the sense of rotation of the rotors for a time period t3-t2 (FIG. 5);
the reverse sense of rotation, conventionally negative sense RPM-, causes the mixture to be pushed towards the discharge chamber 120 from where it exits through the discharge mouth 121;
once the discharge chamber 120 has been emptied the control unit emits a new signal for reversal of the sense of rotation of the rotors so that the machine is set to feed a new batch of ingredients and start a new mixing cycle.

With this operating cycle, the ingredients are kept always in the mixing state inside the mixing chamber 110 which, being open towards the outside and therefore at a substantially atmospheric pressure, does not cause undesirable increases in the temperature, avoiding damaging effects on the mixture such as alteration of the chemico-physical characteristics of the fillers and/or pre-crosslinking of the said mixture.

The pushing of the mixture in the upstream direction and towards the rear wall result in an important technical effect: any mixing material (rubber or additional ingredients, in particular in the form of pellets) fed to the rear part of the mixing chamber comes into contact with the mixture and is therefore incorporated in it, therefore resulting in complete incorporation of the ingredients in the mixture and leaving the machine clean.

Although not shown, it is also envisaged being able to provide the machine with a cover which can be moved so as to open/close the mixing chamber 110, so as to keep the opening open during mixing, in order to maintain a low pressure and low temperature, and instead closed during the discharge step, so as to produce an increase in the area of contact between the mixture and the temporary mixing chamber and therefore axial thrust from upstream to downstream, in order to favour execution of the discharging action.

### EXPERIMENTAL TESTS

The following experimental tests were carried out in a machine according to the invention with a structure and configuration as described above with reference to FIGS. 1-4.

A rotation with a speed “v+” having a positive sign indicates a positive sense of rotation of the feeder screws, corresponding to an advancing direction of the mixture from downstream to upstream, while a negative speed “v-” indicates an opposite sense of rotation of the feeder screws and a direction of advancing movement of the mixture from upstream to downstream.

### Test 1

10,000 g of silicone rubber and 120 g of peroxide, a crosslinking agent in pellet form, were fed to the mixing chamber for mixing thereof.

A temperature of the rubber entering the mixing chamber (Temp-rubber In) was measured before loading, resulting in a temperature of about 25° C.

Table 1 shows the different operating steps performed by the machine at different time instants during the process.

TABLE 1

| | | |
|---|---|---|
| Time | Operating state | |
| T = 0 | Rotors started with positive sense of rotation Loading of 10,000 g of silicone rubber; Loading of 120 g of peroxide; Mixing maintained with v+=10 RPM for 5' | v+=+10 RPM |
| T= 5' | Reduction of speed of rotation | v+= 5 RPM |
| T= 15' | Switching to discharge mode; Reversal of sense of rotation of feeder screws | v-=10 RPM |
| T= 17' | End of discharging of mixture through discharge opening | |

### Results

The temperature (Temp-mixture out) of the mixture extracted from the discharge chamber was measured at different points using a thermal probe.

The temperature, Temp-mixture out, was always less than 35° C., the limit established for passing the test.

The rheometric properties was measured on 10 samples of the mixture extracted. The variation coefficient (std variation/average) for 10 samples was less than 3%.

The mixing chamber was visually inspected and it was noted that no peroxide pellets remained inside the mixing chamber, the rear part of which was clean and free from pellets.

### Test 2 - Colouring of Silicone Rubber with Pigment

50,000 g of silicone rubber were mixed with 500 g of blue pigment in powder form.

The temperature of the rubber, Temp-rubber, was measured at 25° C.

Table 2 shows the different operating steps performed by the machine at different time instants during the process.

TABLE 2

| | | |
|---|---|---|
| Time | Operating state | |
| T = 0 | Rotors started with positive sense of rotation Loading of 50,000 g of silicone rubber | v+=+10 RPM |
| T= 30ʺ | Loading of 500 g of blue pigment in powder form Speed of rotation maintained | v+=10 RPM |
| T=10ʹ30ʺ | Switching to discharge mode; Reversal of sense of rotation of feeder screws | v-=10 RPM |
| T=12ʹ30ʺ | End of discharging of mixture through discharge opening | |

### Results

The temperature (Temp-mixture out) of the mixture extracted from the discharge chamber was measured at different points using a thermal probe.

The temperature, Temp-mixture out, was always less than 35° C., the limit established for passing the test.

The homogeneity of the colour of the mixture was assessed visually. The colour was uniformly distributed without coloured zones.

It is therefore clear how with the machine according to the invention it is possible to perform processing of the mixture at a low pressure, substantially ambient pressure, and with negligible increases in the temperature, while improving the quality of the mixture obtained; in addition the possibility of controlling and determining the direction of the flow of material is able to ensure a movement range suitable for obtaining satisfactory mixing, in particular of all the material fed to the chamber.

Although described in connection with a number of embodiments and a number of preferred examples of implementation of the invention, it is understood that the scope of protection of the present patent is determined solely by the claims below.

1-15. (canceled)

16. A machine for mixing elastomeric materials, comprising
a drive unit (20)
a mixing unit (100) for mixing a mixture, comprising:
a mixing chamber (110) arranged downstream of the drive unit (20) and closed towards upstream by a rear wall (125);
a discharge chamber (120) arranged downstream of the mixing chamber (110), with which it communicates towards upstream, and provided with a discharge opening (121) for discharging the mixture;
a pair of inter-penetrating and counter-rotating conical rotors (131,132), each rotor comprising a respective feeder screw (131a, 132a) mirror-inverted with respect to the other feeder screw;
Wherein the conical rotors are respectively connected upstream to the drive unit (20), whereby the drive unit rotationally drives the conical rotors;
Wherein the conical rotors have their vertices situated at the discharge opening (121) of the discharge chamber (120);
wherein the mixing chamber (110) has at least one opening (110a) towards the exterior, designed to keep it connected with the external environment so as to ensure that its internal pressure remains at substantially atmospheric values,
and wherein machine is configured so that:
during a step for mixing a mixture of the elastomeric materials the rotors are rotated by means of the drive unit (20) only in a first sense of rotation (RPM+) such as to cause the mixture to be pushed towards the rear wall (125) of the mixing chamber, so as to keep mixing active only inside the mixing chamber at a substantially atmospheric pressure during the mixing step,
and, during a subsequent mixture discharge step, the rotors are rotated only in a second sense of rotation, opposite to the first sense of rotation, such as to cause the mixture to be pushed towards the discharge chamber (120) and the discharge opening (121).

17. The machine according to claim 16, wherein the mixing chamber (110) and the discharge chamber (120) are frustoconical and axially connected together.

18. The machine according to claim 16, comprising a loading opening (123) for loading an ingredients to be mixed.

19. The machine according to claim 18, wherein said loading opening (123) is one of said at least one opening (110a) towards the exterior of the mixing chamber.

20. The machine according to claim 16, wherein said drive unit (20) comprises at least one motor (21) with a drive shaft (21a) arranged for rotationally moving one (131;132) of the two conical rotors and a transmission (22) designed to reverse the direction of rotation of the drive shaft (21a) and connected to the other conical rotor.

21. The machine according to claim 16, comprising control means (500) for controlling and actuating the moving parts of the machine, designed to perform automatic operation thereof.

22. The machine according to claim 21, wherein the control means (500) are configured to automatically send to the drive unit (20) a reversal command for reversing the sense of rotation of the conical rotors (132;132) upon completion of the mixing step.

23. The machine according to claim 16, comprising at least one cover movable into a closed or open position so as to close the mixing chamber (110) during axial discharging of the mixture.

24. The machine according claim 16, wherein the discharge opening (121) for discharging the mixture is always open towards the external environment, there being no means for closing the discharge opening.

25. A process for mixing elastomeric materials by means of a machine, wherein the machine comprises:
a drive unit (20)
a mixing unit (100) for mixing a mixture, comprising:
a mixing chamber (110) arranged downstream of the drive unit (20) and closed towards upstream by a rear wall (125);
a discharge chamber (120) arranged downstream of the mixing chamber (110), with which it communicates towards upstream, and provided with a discharge opening (121) for discharging the mixture;
a pair of inter-penetrating and counter-rotating conical rotors (131,132), each rotor comprising a respective feeder screw (131a, 132a) mirror-inverted with respect to the other feeder screw;
Wherein the conical rotors are respectively connected upstream to the drive unit (20), whereby the drive unit rotationally drives the conical rotors;
Wherein the conical rotors have their vertices situated at the discharge opening (121) of the discharge chamber (120);
wherein the mixing chamber (110) has at least one opening (110a) towards the exterior, designed to keep it connected with the external environment so as to ensure that its internal pressure remains at substantially atmospheric values,
the method comprising the steps of:
loading ingredients to be mixed into the mixing chamber;
mixing the ingredients by the feeder screws (131a, 132a) to obtain a mixture, with rotation of the conical rotors (131,132) only in a first sense of rotation (RPM+) which causes the mixture to be pushed towards the rear wall (125) so as to keep mixing active only inside the mixing chamber at substantially atmospheric pressure;
discharging the mixture, comprising reversal of the sense of rotation of the conical rotors which are made to rotate with a second sense of rotation (RPM-), opposite to the first sense of rotation, for a time period (t3-t2) such as to cause the mixture to be pushed towards the discharge chamber (120) and discharged through the discharge opening (121).

26. The process according to claim 25, characterized in that, during the mixing step, the rotation of the rotors in the first sense of rotation (RPM+) causes:
a reaction on the rear wall (125) such as to impart a component of the movement of the mixture in the axial direction from upstream (P) to downstream (A);
formation of a movement range designed to cause three separate movements of the mixture, respectively a circumferential movement (I), a main axial flow (II) and a secondary axial flow (III).

27. The process according to claim 25, wherein loading of the ingredients is performed via a loading opening (123;110a).

28. The process according to claim 27, wherein the loading opening is closed during the discharging step.

29. The process according to claim 25, wherein the mixing step comprises:
starting rotation of the rotors (131,132) in a first sense of rotation (RPM+),
take-up of the ingredients by the feeder screws (131a,132a) and starting of the mixing operation with pushing of the mixture towards the rear wall (125) situated upstream (P);
maintaining the first sense of rotation (RPM+) for a mixing time period (t1) until completion of the mixing operation;
and/or in that the discharging step comprises the steps of:
sending, manually or by control means (500), a reversal command for reversing the sense of rotation (RPM+) of the two conical rotors (131,132);
reversal of the sense of rotation of the conical rotors which are made to rotate with a second negative sense of rotation (RPM-) for a time period (t3-t2) such as to cause the mixture to be pushed towards the discharge chamber (120) and discharged through the discharge opening (121).

30. The process according to claim 29, characterized in that, during the mixing step, the opening (121) for discharging the mixture is always open towards the external environment.

31. The process according to claim 22 wherein the control means (500) are configured to automatically send to the drive unit (20) the reversal command after a predefined mixing time (t1).

32. Process according to claim 27, where the loading opening (123;110a) is one of said at least one opening (110) towards the exterior of the mixing chamber.
